(19) United States
(12) Patent Application Publication
(10) Pub. No.: US 2026/0018049 A1
(43) Pub. Date: Jan. 15, 2026

(54) TRAFFIC MONITORING DEVICE, TRAFFIC MONITORING METHOD, AND NON-TRANSITORY COMPUTER-READABLE MEDIUM

(71) Applicant: NEC Corporation, Tokyo (JP)

(72) Inventors: Yuma MATSUDA, Tokyo (JP); Shin TOMINAGA, Tokyo (JP); Yasuharu HAYASHI, Tokyo (JP); Hitoshi SAKURAI, Tokyo (JP)

(73) Assignee: NEC Corporation, Tokyo (JP)

(21) Appl. No.: 19/247,527

(22) Filed: Jun. 24, 2025

(30) Foreign Application Priority Data
Jul. 11, 2024 (JP) 2024-111726

(51) Int. Cl. G08G 1/01; G08G 1/04; G08G 1/052

(52) U.S. Cl. CPC G08G 1/0129; G08G 1/0116; G08G 1/0133; G08G 1/04; G08G 1/052

(57) ABSTRACT

A traffic monitoring device according to the present disclosure includes at least one memory in which instructions are stored, and at least one processor configured to, by executing the instructions, acquire vibration data indicating vibration generated by a vehicle traveling on a road from a measurement device that performs optical fiber sensing using an optical fiber laid along the road, calculate, for each section of the road, an average speed value of a vehicle group traveling in the section based on the acquired vibration data, and detect stopping of the vehicle group or traveling at a speed equal to or lower than a threshold value for the vehicle group based on a temporal transition of the average speed value for each section of the road.

### INCORPORATION BY REFERENCE

This application is based upon and claims the benefit of priority from Japanese patent application No. 2024-111726, filed on Jul. 11, 2024, the disclosure of which is incorporated herein in its entirety by reference.

### TECHNICAL FIELD

The present disclosure relates to a traffic monitoring device, a traffic monitoring method, and a non-transitory computer-readable medium.

### BACKGROUND ART

In December 2020, several thousands of vehicles were stuck on the Kanetsu expressway due to heavy snow.

Therefore, in recent years, early detection of stopping of a vehicle group on a road or traveling at a speed equal to or lower than a threshold value for a vehicle group (traveling at a speed close to stopping of the vehicle group) on the road has been emphasized.

Monitoring cameras such as closed-circuit television (CCTV) cameras are installed at short intervals on highways in urban areas. Therefore, the above detection can be performed relatively early using monitoring cameras.

On the other hand, almost no monitoring cameras are installed on suburban highways where the influence of heavy snow is of concern. Therefore, in order to perform the above detection using monitoring cameras, the cost for installation and maintenance of monitoring cameras becomes enormous.

Therefore, recently, optical fiber sensing capable of continuously monitoring a traffic flow on a road at low cost using an optical fiber already laid for communication has attracted attention, and it is expected to perform the above detection using optical fiber sensing.

For example, Patent Literature 1 discloses a technique of acquiring a vehicle position on a road by optical fiber sensing, and detecting a traffic jam on the road by using pattern matching between a history of vehicle positions and a matching pattern that is a traffic jam pattern (a pattern of a history of vehicle positions in a case where a traffic jam has occurred) or a learning model that learns a traffic jam pattern.
[Patent Literature 1] International Patent Publication No. WO 2022/185922

### SUMMARY

As described above, according to the technique disclosed in Patent Literature 1, it is possible to detect a traffic jam on a road using optical fiber sensing.

However, the technique disclosed in Patent Literature 1 has a problem that it is necessary to prepare a matching pattern or a learning model in advance.

Therefore, an object of the present disclosure is to provide a traffic monitoring device, a traffic monitoring method, and a non-transitory computer-readable medium capable of detecting stopping of a vehicle group on a road or traveling of the vehicle group at a speed equal to or less than a threshold value on the road without preparing a matching pattern or a learning model in advance.

A traffic monitoring device according to one aspect includes
at least one memory in which instructions are stored, and
at least one processor configured to, by executing the instructions,
   acquire vibration data indicating vibration generated by a vehicle traveling on a road from a measurement device that performs optical fiber sensing using an optical fiber laid along the road, and calculate, for each section of the road, an average speed value of a vehicle group traveling in the section based on the acquired vibration data, and
   detect stopping of the vehicle group or traveling at a speed equal to or lower than a threshold value for the vehicle group based on a temporal transition of the average speed value for each section of the road.

A traffic monitoring method according to one aspect is
a traffic monitoring method executed by a traffic monitoring device, the traffic monitoring method including
acquiring vibration data indicating vibration generated by a vehicle traveling on a road from a measurement device that performs optical fiber sensing using an optical fiber laid along the road, calculating, for each section of the road, an average speed value of a vehicle group traveling in the section based on the acquired vibration data, and
detecting a stopping of the vehicle group or traveling at a speed equal to or lower than a threshold value for the vehicle group based on a temporal transition of an average speed value for each section of the road.

A non-transitory computer-readable medium according to one aspect is a non-transitory computer-readable medium storing a program causing a computer to execute
a calculation procedure of acquiring vibration data indicating vibration generated by a vehicle traveling on a road from a measurement device that performs optical fiber sensing using an optical fiber laid along the road, and calculating, for each section of the road, an average speed value of a vehicle group traveling in the section based on the acquired vibration data, and
a detection procedure of detecting stopping of the vehicle group or traveling at a speed equal to or lower than a threshold value for the vehicle group based on a time transition of an average speed value for each section of the road.

According to the above-described aspect, it is possible to provide a traffic monitoring device, a traffic monitoring method, and a non-transitory computer-readable medium capable of detecting stopping of a vehicle group on a road or traveling of the vehicle group at a speed equal to or less than a threshold value on the road without preparing a matching pattern or a learning model in advance.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram showing a schematic configuration example of a traffic monitoring system according to the present disclosure;

FIG. 2 is a diagram illustrating an example in which vibration data derived by a measurement device according to the present disclosure is visualized;

FIG. 3 is a diagram illustrating an example of a detection operation performed by a detection unit according to the present disclosure;

FIG. 4 is a diagram illustrating an example of the detection operation performed by the detection unit according to the present disclosure;

FIG. 5 is a diagram illustrating an example of the detection operation performed by the detection unit according to the present disclosure;

FIG. 6 is a flowchart illustrating an example of a flow of a schematic operation of a traffic monitoring device according to the present disclosure; and

FIG. 7 is a block diagram showing a schematic hardware configuration example of a computer that implements the traffic monitoring device according to the present disclosure.

### EXAMPLE EMBODIMENTS

Hereinafter, example embodiments of the present disclosure will be described with reference to the drawings. The following description and drawings are omitted and simplified as appropriate for clarity of description. In the following drawings, the same elements are denoted by the same reference numerals, and redundant description is omitted as necessary. Specific numerical values and the like shown below are merely examples for facilitating understanding of the present disclosure, and are not limited thereto.

First, a configuration example of a traffic monitoring system 1 according to the present disclosure will be described.

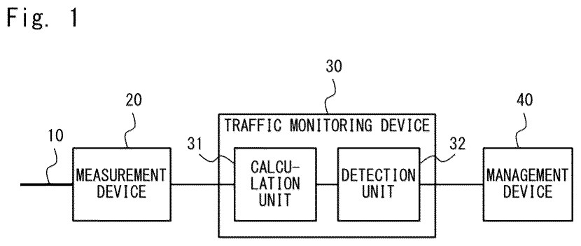

FIG. 1 is a diagram showing a schematic configuration example of the traffic monitoring system 1 according to the present disclosure.

As shown in FIG. 1, the traffic monitoring system 1 according to the present disclosure includes a measurement device 20, a traffic monitoring device 30, and a management device 40.

An optical fiber 10 is laid along a road R as described later. As long as the optical fiber 10 is laid along the road R, a method for laying the optical fiber is not particularly limited. Hereinafter, it is assumed that the optical fiber 10 is embedded in the road R along the road R, but may be overhead wired to a structure such as a utility pole.

The measurement device 20 is connected to the optical fiber 10 laid along the road R.

Therefore, the measurement device 20 is installed in the vicinity of the road R. On the other hand, the traffic monitoring device 30 and the management device 40 may be installed in any place, for example, on the cloud.

The measurement device 20 performs optical fiber sensing using the optical fiber 10 laid along the road R, and is implemented by, for example, a distributed acoustic sensing (DAS) device. Specifically, the measurement device 20 measures vibration generated by a vehicle traveling on the road R based on an optical signal (backscattered light) received from the optical fiber 10.

Further, the measurement device 20 derives vibration data indicating the vibration measured by optical fiber sensing. Specifically, the measurement device 20 derives vibration data obtained by integrating vibrations measured by optical fiber sensing for a certain period of time in a time direction and a distance direction.

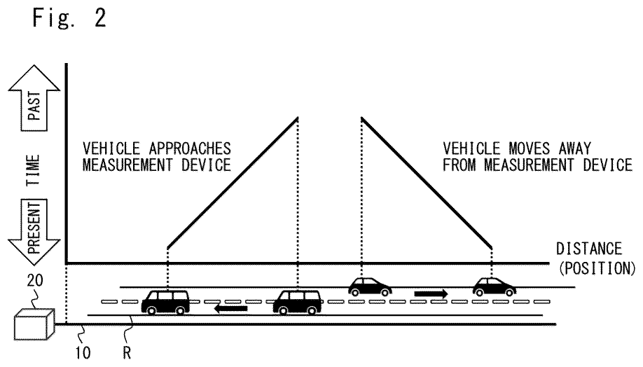

FIG. 2 is a diagram illustrating an example in which vibration data derived by the measurement device 20 is visualized.

In FIG. 2, the lower diagram shows a traffic condition of the road R. The upper diagram illustrates the vibration data, the horizontal axis indicates the position where vibration is generated (the distance of the optical fiber 10 from the measurement device 20), and the vertical axis indicates the time at which the vibration is generated. In addition, the more positive along the vertical axis, the older the data.

In the vibration data shown in FIG. 2, the fact that one vehicle is traveling on the road R is represented by one oblique line. Positive and negative inclinations of lines represent directions in which vehicles travel. In the example of FIG. 2, a vehicle represented by a line with a positive inclination is traveling in a direction approaching the measurement device 20, and a vehicle represented by a line with a negative inclination travels in a direction away from the measurement device 20. The absolute value of the inclination of a line represents the speed of a vehicle. In the example of FIG. 2, the smaller the absolute value of the inclination of the line, the faster the speed of the vehicle.

The traffic monitoring device 30 includes a calculation unit 31 and a detection unit 32.

The calculation unit 31 acquires vibration data (for example, vibration data visualized as in FIG. 2) derived by the measurement device 20, and calculates, for each section of the road R, an average speed value of a vehicle group traveling in the section based on the acquired vibration data.

The detection unit 32 detects stopping of the vehicle group or traveling at a speed equal to or lower than a threshold value for the vehicle group based on the temporal transition of the average speed value for each section of the road R calculated by the calculation unit 31. Traveling at a speed equal to or lower than the threshold value for the vehicle group means traveling at a speed close to stopping of the vehicle group. Therefore, the threshold value may be set to any speed within a range of, for example, more than 0 km/h and 20 km/h or less. Details of the detection operation performed by the detection unit 32 will be described later.

The detection unit 32 notifies the management device 40 of a result of detection of stopping of the vehicle group or traveling at a speed equal to or lower than the threshold value for the vehicle group.

The management device 40 is a device that receives, from the detection unit 32, a notification of the result of detection of stopping of the vehicle group or traveling at a speed equal to or lower than the threshold value for the vehicle group. The management device 40 is implemented by, for example, a device installed in a road control center or the like.

Next, details of the detection operation performed by the detection unit 32 will be described.

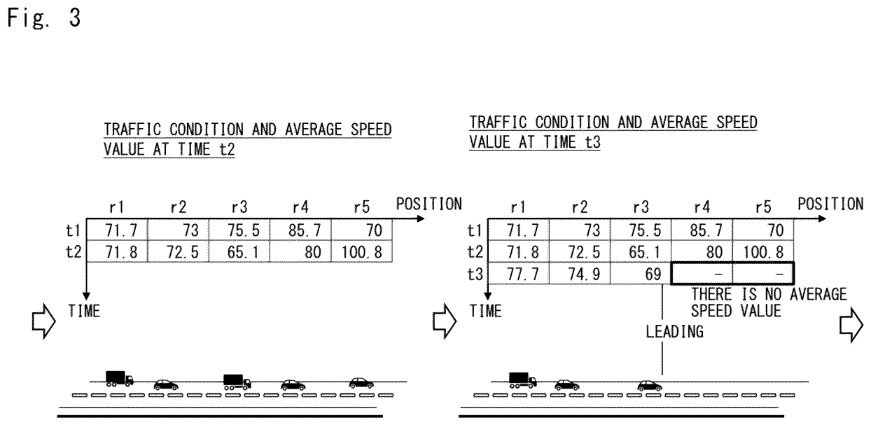

FIGS. 3 to 5 are diagrams illustrating an example of the detection operation performed by the detection unit 32.

In FIGS. 3 to 5, the lower diagram illustrates traffic conditions of the road R at each time. The upper diagram illustrates the temporal transition of an average speed value for each of sections r1 to r5 of the road R until the time of the lower diagram, in which the horizontal axis indicates the position (distance of the optical fiber 10 from the measurement device 20) and the vertical axis indicates time. The vertical axis indicates newer data toward the negative direction (downward direction in the drawing). The calculation unit 31 calculates an average speed value at 1 minute intervals. Therefore, t(n+1)=t(n)+1 (n=1, 2, 3, . . . ).

As shown in FIG. 3, at time t2, the traffic flow is in a normal state. At this time, there are average speed values in all the sections r1 to r5.

Subsequent time t3 is a state in which the vehicle group stops or the vehicle group is traveling at a speed equal to or lower than the threshold value. At this time, there is no average speed value in the front sections r4 and r5. On the other hand, there is an average speed value in the rear section r3.

In a case where the vehicle group stops, vibration caused by traveling of the vehicles does not occur, and thus, vibration caused by traveling of the vehicles cannot be detected through optical fiber sensing by the measurement device 20. In a case where the vehicle group is traveling at a speed equal to or lower than the threshold value, only a weak vibration that cannot be distinguished from stopping can be detected through optical fiber sensing by the measurement device 20. Therefore, in a state in which the vehicle group stops or the vehicle group is traveling at a speed equal to or lower than the threshold value, the calculation unit 31 cannot calculate the average speed value of the vehicle group, and thus there is no average speed value.

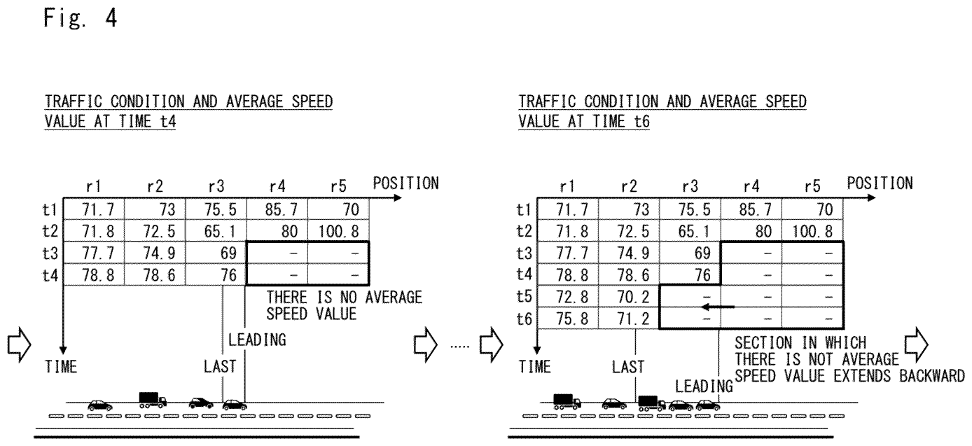

As shown in FIG. 4, at subsequent time t4, a state in which the vehicle group stops or the vehicle group is traveling at a speed equal to or lower than the threshold value continues from time t3.

Subsequent time t6 is a state in which a section in which the vehicle group stops or the vehicle group is traveling at a speed equal to or lower than the threshold value extends backward. At this time, a following vehicle gradually stops or is traveling at a speed equal to or less than the threshold value. Therefore, there is no average speed value in the section r3. That is, the section in which there is no average speed value extends backward. The length of the section r3 corresponds to an extension of the length of the vehicle group that stops or is traveling at a speed equal to or less than the threshold value.

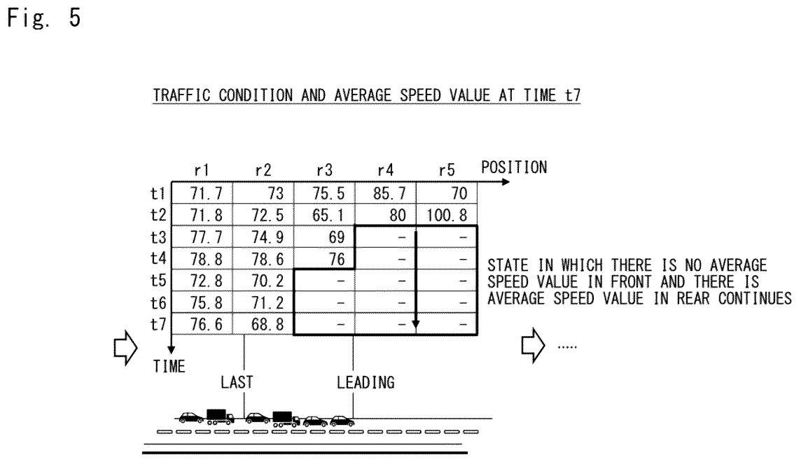

As shown in FIG. 5, at subsequent time t7, a state in which the vehicle group stops or the vehicle group is traveling at a speed equal to or lower than the threshold value continues from time t6.

As shown in FIGS. 3 to 5, in a case where the vehicle group stops or the vehicle group is traveling at a speed equal to or lower than the threshold value, there is a section ahead in which there is no average speed value, and there is a section behind in which there is an average speed value. This state continues as long as the vehicle group stops or the vehicle group is traveling at a speed equal to or lower than the threshold value.

Based on the above, in a case where there is a section ahead in which there is no average speed value and there is a section behind in which there is an average speed value, detection unit 32 may detect stopping of the vehicle group or traveling at a speed equal to or lower than the threshold value for the vehicle group.

However, a similar state can be obtained if there is only one snow-removing vehicle or a broken-down vehicle stops at the time of snow accumulation.

Therefore, in a case where a state in which there is a section ahead in which there is no average speed value and there is a section behind in which there is an average speed value continues for a predetermined period, the detection unit 32 may detect stopping of the vehicle group or traveling at a speed equal to or lower than the threshold value for the vehicle group.

In a case where the detection unit 32 detects stopping of the vehicle group or traveling at a speed equal to or lower than the threshold value for the vehicle group, the detection unit 32 may notify the management device 40 of the detection result.

The detection unit 32 may identify the length of the vehicle group that stops or is traveling at a speed equal to or less than the threshold value based on the length of a section ahead in which there is no average speed value and the length of a section behind in which there is an average speed value. For example, in the case of the time t3 and time t4, the detection unit 32 may identify the length of the vehicle group that stops or is traveling at a speed equal to or less than the threshold value as the length of the section r3. In the case of the time t6 and time t7, the detection unit 32 may identify the length of the vehicle group that stops or is traveling at a speed equal to or less than the threshold value as the lengths of the sections r2 and r3.

Next, an example of the operation flow of the traffic monitoring device 30 will be described.

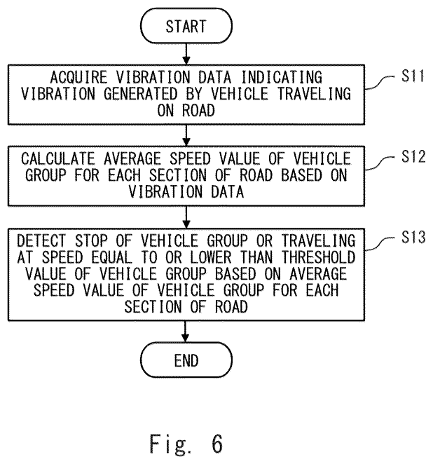

FIG. 6 is a flowchart illustrating an example of a schematic operation flow of the traffic monitoring device 30.

As shown in FIG. 6, first, the calculation unit 31 acquires vibration data indicating vibration generated by a vehicle traveling on the road R from the measurement device 20 that performs optical fiber sensing using the optical fiber 10 laid along the road R (step S11).

Next, the calculation unit 31 calculates, for each section of the road R, an average speed value of a vehicle group traveling in the section based on the vibration data acquired from the measurement device 20 (step S12).

Thereafter, the detection unit 32 detects stopping of the vehicle group or traveling at a speed equal to or lower than the threshold value for the vehicle group based on the temporal transition of the average speed value for each section of the road R calculated by the calculation unit 31 (step S13).

As described above, according to the present example embodiment 1, the calculation unit 31 acquires vibration data indicating vibration generated by a vehicle traveling on the road R from the measurement device 20 that performs optical fiber sensing using the optical fiber 10 laid along the road R, and calculates, for each section of the road R, an average speed value of a vehicle group traveling in the section based on the acquired vibration data. The detection unit 32 detects stopping of the vehicle group or traveling at a speed equal to or lower than the threshold value for the vehicle group based on the temporal transition of the average speed value for each section of the road R. This makes it possible to detect stopping of the vehicle group on the road R or traveling of the vehicle group at a speed equal to or less than the threshold value on the road R without preparing a matching pattern or a learning model in advance.

### <Hardware Configuration of Traffic Monitoring Device>

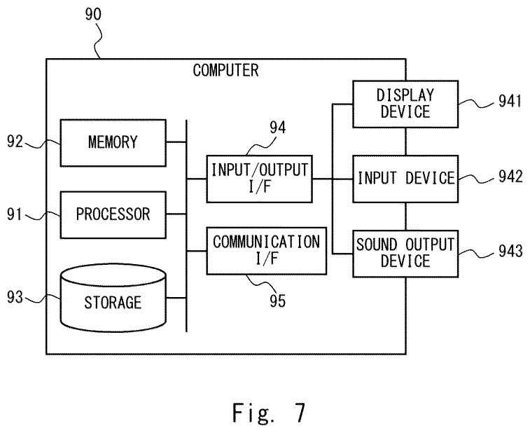

FIG. 7 is a block diagram showing a schematic hardware configuration example of a computer 90 that implements the traffic monitoring device 30.

As shown in FIG. 7, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is an arithmetic processing unit such as a central processing unit (CPU) or a graphics processing unit (GPU). The memory 92 is, for example, a memory such as a random access memory (RAM) or a read only memory (ROM). The storage 93 is a storage device such as a hard disk drive (HDD), a solid state drive (SSD), or a memory card. The storage 93 may be a memory such as a RAM or a ROM.

A program is stored in the storage 93. This program includes a command group (or software code) for causing the computer 90 to perform one or more functions in the traffic monitoring device 30 described above if read by the computer. The components of the traffic monitoring device 30 described above may be implemented by the processor 91 reading and executing a program stored in the storage 93. The storage function in the traffic monitoring device 30 described above may be implemented by the memory 92 or the storage 93.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display device 941, an input device 942, a sound output device 943, and the like. The display device 941 is a device that displays a screen related to drawing data processed by the processor 91, such as a liquid crystal display (LCD), a cathode ray tube (CRT) display, or a monitor. The input device 942 is a device that receives an operation input of an operator, and is, for example, a keyboard, a mouse, a touch sensor, or the like. The display device 941 and the input device 942 may be integrated and implemented as a touch panel. The sound output device 943 is a device that acoustically outputs a sound corresponding to acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A traffic monitoring device including:
at least one memory in which instructions are stored; and
at least one processor configured to, by executing the instructions:
   acquire vibration data indicating vibration generated by a vehicle traveling on a road from a measurement device that performs optical fiber sensing using an optical fiber laid along the road, and calculate, for each section of the road, an average speed value of a vehicle group traveling in the section based on the acquired vibration data; and
   detect stopping of the vehicle group or traveling at a speed equal to or lower than a threshold value for the vehicle group based on a temporal transition of the average speed value for each section of the road.

### Supplementary Note 2

The traffic monitoring device according to supplementary note 1, wherein the at least one processor is configured to detect stopping of the vehicle group or traveling at a speed equal to or lower than the threshold value for the vehicle group in a case where there is a section ahead in which there is no average speed value and there is a section behind in which there is an average speed value.

### Supplementary Note 3

The traffic monitoring device according to supplementary note 1, wherein the at least one processor is configured to detect stopping of the vehicle group or traveling at a speed equal to or lower than the threshold value for the vehicle group in a case where a state in which there is a section ahead in which there is no average speed value and there is a section behind in which there is an average speed value continues for a predetermined period.

### Supplementary Note 4

The traffic monitoring device according to supplementary note 2, wherein the at least one processor is configured to identify a length of the vehicle group that stops or is traveling at a speed equal to or lower than the threshold value based on a length of a section ahead in which there is no average speed value and a length of a section behind in which there is an average speed value.

### Supplementary Note 5

The traffic monitoring device according to supplementary note 1, wherein the at least one processor is configured to, in a case where detecting stopping of the vehicle group or traveling at a speed equal to or lower than the threshold value for the vehicle group, notify a management device of a detection result.

### Supplementary Note 6

A traffic monitoring system including:
the traffic monitoring device according to supplementary note 5;
the measurement device; and
the management device.

### Supplementary Note 7

A traffic monitoring method executed by a traffic monitoring device, the traffic monitoring method including:
acquiring vibration data indicating vibration generated by a vehicle traveling on a road from a measurement device that performs optical fiber sensing using an optical fiber laid along the road, and calculating, for each section of the road, an average speed value of a vehicle group traveling in the section based on the acquired vibration data; and
detecting stopping of the vehicle group or traveling at a speed equal to or lower than a threshold value for the vehicle group based on a temporal transition of the average speed value for each section of the road.

### Supplementary Note 8

The traffic monitoring method according to supplementary note 7, wherein the detecting stopping of the vehicle group or traveling at a speed equal to or lower than a threshold value for the vehicle group includes detecting stopping of the vehicle group or traveling at a speed equal to or lower than the threshold value for the vehicle group in a case where there is a section ahead in which there is no average speed value and there is a section behind in which there is an average speed value.

### Supplementary Note 9

A non-transitory computer-readable medium storing a program causing a computer to execute:
a calculation procedure of acquiring vibration data indicating vibration generated by a vehicle traveling on a road from a measurement device that performs optical fiber sensing using an optical fiber laid along the road, and calculating, for each section of the road, an average speed value of a vehicle group traveling in the section based on the acquired vibration data; and
a detection procedure of detecting stopping of the vehicle group or traveling at a speed equal to or lower than a threshold value for the vehicle group based on a time transition of an average speed value for each section of the road.

### Supplement Note 10

The non-transitory computer-readable medium according to supplementary note 9, wherein in the detection procedure, stopping of the vehicle group or traveling at a speed equal to or lower than the threshold value for the vehicle group is detected in a case where there is a section ahead in which there is no average speed value and there is a section behind in which there is an average speed value.

Note that, some or all of elements (e.g., structures and functions) specified in Supplementary Notes 2 to 5 dependent on Supplementary Note 1 may also be dependent on Supplementary Notes 7 and 9 in dependency similar to that of Supplementary Notes 2 to 5 dependent on Supplementary Note 1. Some or all of elements specified in any of Supplementary Notes may be applied to various types of hardware, software, and recording means for recording software, systems, and methods.

What is claimed is:

1. A traffic monitoring device comprising:
at least one memory in which instructions are stored; and
at least one processor configured to, by executing the instructions:
acquire vibration data indicating vibration generated by a vehicle traveling on a road from a measurement device that performs optical fiber sensing using an optical fiber laid along the road, and calculate, for each section of the road, an average speed value of a vehicle group traveling in the section based on the acquired vibration data; and
detect stopping of the vehicle group or traveling at a speed equal to or lower than a threshold value for the vehicle group based on a temporal transition of the average speed value for each section of the road.

2. The traffic monitoring device according to claim 1, wherein the at least one processor is configured to detect stopping of the vehicle group or traveling at a speed equal to or lower than the threshold value for the vehicle group in a case where there is a section ahead in which there is no average speed value and there is a section behind in which there is an average speed value.

3. The traffic monitoring device according to claim 1, wherein the at least one processor is configured to detect stopping of the vehicle group or traveling at a speed equal to or lower than the threshold value for the vehicle group in a case where a state in which there is a section ahead in which there is no average speed value and there is a section behind in which there is an average speed value continues for a predetermined period.

4. The traffic monitoring device according to claim 2, wherein the at least one processor is configured to identify a length of the vehicle group that stops or is traveling at a speed equal to or lower than the threshold value based on a length of a section ahead in which there is no average speed value and a length of a section behind in which there is an average speed value.

5. The traffic monitoring device according to claim 1, wherein the at least one processor is configured to, in a case where detecting stopping of the vehicle group or traveling at a speed equal to or lower than the threshold value for the vehicle group, notify a management device of a detection result.

6. A traffic monitoring method executed by a traffic monitoring device, the traffic monitoring method comprising:
acquiring vibration data indicating vibration generated by a vehicle traveling on a road from a measurement device that performs optical fiber sensing using an optical fiber laid along the road, and calculating, for each section of the road, an average speed value of a vehicle group traveling in the section based on the acquired vibration data; and
detecting stopping of the vehicle group or traveling at a speed equal to or lower than a threshold value for the vehicle group based on a temporal transition of an average speed value for each section of the road.

7. The traffic monitoring method according to claim 6, wherein the detecting stopping of the vehicle group or traveling at a speed equal to or lower than a threshold value for the vehicle group comprises detecting stopping of the vehicle group or traveling at a speed equal to or lower than the threshold value for the vehicle group in a case where there is a section ahead in which there is no average speed value and there is a section behind in which there is an average speed value.

8. A non-transitory computer-readable medium storing a program causing a computer to execute:
a calculation procedure of acquiring vibration data indicating vibration generated by a vehicle traveling on a road from a measurement device that performs optical fiber sensing using an optical fiber laid along the road, and calculating, for each section of the road, an average speed value of a vehicle group traveling in the section based on the acquired vibration data; and
a detection procedure of detecting stopping of the vehicle group or traveling at a speed equal to or lower than a threshold value for the vehicle group based on a time transition of an average speed value for each section of the road.

9. The non-transitory computer-readable medium according to claim 8, wherein, in the detection procedure, stopping of the vehicle group or traveling at a speed equal to or lower than the threshold value for the vehicle group is detected in a case where there is a section ahead in which there is no average speed value and there is a section behind in which there is an average speed value.
